(19) United States
(12) Patent Application Publication
(10) Pub. No.: US 2014/0095862 A1
(43) Pub. Date: Apr. 3, 2014

(54) SECURITY ASSOCIATION DETECTION FOR INTERNET PROTOCOL SECURITY

(71) Applicant: Hangzhou H3C Technologies Co., Ltd., Hangzhou (CN)

(72) Inventor: Chao YANG, Beijing (CN)

(73) Assignee: Hangzhou H3C Technologies Co., Ltd., Hangzhou (CN)

(21) Appl. No.: 14/039,983

(22) Filed: Sep. 27, 2013

(30) Foreign Application Priority Data
Sep. 28, 2012 (CN) 201210372170.3

(51) Int. Cl. H04L 29/06

(52) U.S. Cl. CPC H04L 63/164
USPC 713/151

(57) ABSTRACT

According to an example, a detection message may be sent for security association detection for Internet protocol security. The detection message includes a detection flag. The detection message may be an encapsulated message including the detection flag.

### BACKGROUND

IPsec (Internet Protocol Security) refers to a series of layer 3 tunnel encryption protocols defined by the Internet Engineering Task Force (IETF) to provide high quality, interoperable, and cryptology-based security for data transmitted over the Internet and it is a conventional security technique for implementing a layer 3 virtual private network (VPN). Certain communication parties establish IPsec tunnels therebetween to transmit users' private data, and deliver the following security services at the IP layer: data confidentiality; data integrity; data origin authentication; and anti-replay.

For data confidentiality, the IPsec sender encrypts messages before transmitting them over the network. For data integrity, the IPsec receiver verifies the messages received from the sender to ensure they are not tampered during transmission. For data origin authentication, the IPsec receiver can authenticate the legality of the sender which sent IPsec messages. For anti-replay, the IP receiver can examine messages and reject outdated or repeated messages.

IPsec provides two kinds of security mechanisms: authentication and encryption. The authentication mechanism enables the data receiver of an IP communication to determine the true identity of the data sender and whether the data has been tampered during transmission. The encryption mechanism performs encryption on data to ensure the confidentiality of data so as to prevent the data from being intercepted during transmission.

IPsec provides secure communication between two ends, which are called IPsec peers. Security Association (SA) is a set of agreements between communication peers in regard to such aspects as the protocol(s) to be used (e.g., Authentication Header (AH) or Encapsulating Security Payload (ESP) or both), encapsulation mode of protocol (transport mode or tunnel mode), encryption algorithm, shared key used for data protection in specific flows, and key lifetime. IPsec can establish SA by Internet Key Exchange (IKE) negotiation.

### DESCRIPTION OF THE DRAWINGS

FIG. 1 is a diagram of a network device provided by an example of the present disclosure.

FIG. 2 is a diagram of another network device provided by an example of the present disclosure.

FIG. 3 is a flow diagram of an implementation method provided by an example of the present disclosure.

FIG. 4 is a flow diagram of another implementation method provided by an example of the present disclosure.

FIG. 5 is a schematic diagram of message encapsulation under the AH transport mode provided by an example of the present disclosure.

FIG. 6 is a diagram of a message format provided by an example of the present disclosure.

FIG. 7 is a schematic diagram of message encapsulation under the AH tunnel mode provided by an example of the present disclosure.

FIG. 8 is a schematic diagram of message encapsulation under the AH transport mode provided by an example of the present disclosure.

FIG. 9 is a schematic diagram of message encapsulation under the ESP tunnel mode provided by an example of the present disclosure.

FIG. 10 shows an example of a computer device.

### DETAILED DESCRIPTION

Dead Peer Detection (DPD) determines the state of IPsec SA by detecting the state of IKE SA corresponding to the IPsec SA. The active detecting party sends an R-U-THERE message and the detected party replies with an R-U-THERE-ACK message when it receives the R-U-THERE message. After receiving the R-U-THERE-ACK message, the active detecting party determines that the opposite end is online. Both messages are announcement loads of ISAKMP and both are encrypted using IKE SA.

DPD detection might not be accurate. Since DPD messages are protected by IKE SA, if IKE SA of the opposite end does not exist but IPsec SA exists, then DPD detection fails.

The present disclosure provides a network device, when acting as an IPsec peer, for detecting whether IPsec SA of an opposite end IPsec peer is normal or not. IPsec SA of an IPsec peer is normal if the IPsec peer can perform the functions of IPsec SA to communicate with another IPsec peer through the IPsec tunnel established between the peers. Due to certain circumstances, such as route selection, peer restarting, etc., IPsec peers may lose connectivity. The loss of IP connectivity between IPsec peers can render IPsec SA at an IPsec peer not normal because one or both of the IPsec peers may be unable to communicate through the IPsec tunnel.

For example, IPsec peers may use IKE to negotiate keys and establishes SA for IPsec in two phases. In phase 1, the communication parties establish a secured and authenticated channel for communication, i.e. an Internet Security Association and Key Management Protocol (ISAKMP) SA. In this phase, two modes are available: main mode and aggressive mode. In phase 2, using the secure tunnel established in phase 1, the communication parties negotiate secure services for IPsec, i.e. negotiate to establish IPsec SA to be used for final secure IP data transmission.

Also, IPsec is a peer-to-peer technique. In order to establish an IPsec session between IPsec peers, there has to be IP connectivity between peers. However, if IP connectivity is lost, IPsec SA becomes not normal. Before expiration of the lifetime, IKE and IPsec SA between IPsec peers always exists and interruption of the IPsec session, for example due to loss of IP connectivity, causes a “blackhole”, which results in loss of data streams and wasted resources. For example, one IPsec peer continues to encrypt data streams that are intended for the unreachable IPsec peer, which greatly wastes CPU resources. Also, standby peers cannot be activated because the failure of the peers cannot be detected. A network device, according to an example of the present disclosure, when acting as an IPsec peer, can detect whether IPsec SA of an opposite end IPsec peer is normal or not to mitigate causing a “blackhole”.

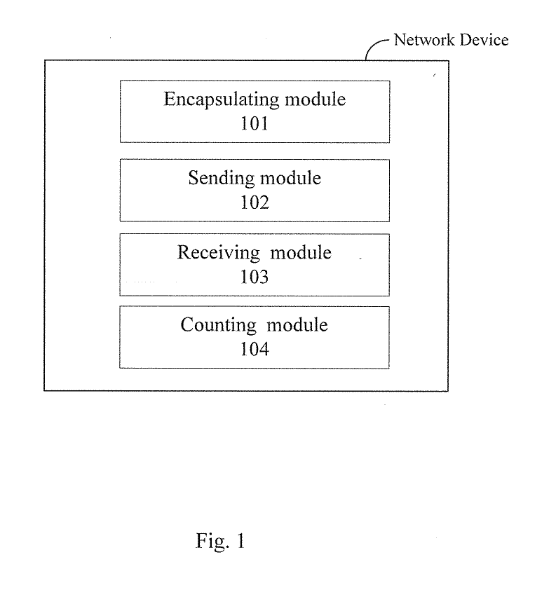

As shown in FIG. 1, a network device according to an example may include an encapsulating module 101 to encapsulate a message including a detection flag into an IPsec SA detection message, a sending module 102, a receiving module 103 and a counting module 104. The payload content of the detection message may be a sequence number encrypted and authenticated by IPsec SA. A sequence number may be a number (e.g., a 32-bit number) that increases by a predetermined amount for evener packet that is sent. For example, the sequence number may by a monotonic increasing number incremented by 1 for every packet sent. The function of the sequence number is to further enable the peer to determine that the received IPsec SA message is a response message. This improves the reliability in determining that IPsec SA of the opposite end peer is alive and the IPsec SA is normal. The payload content of the detection message may also be any content. As long as the local end peer, after receiving a response message, may determine that the payload content of the response message is encrypted using IPsec SA corresponding to IPsec SA of the local end and may be decrypted normally by the local end, it may be determined that the IPsec SA of the opposite end peer can work normally. Whether the IPsec SAs are corresponding to each other can be determined based on a relevant field in the header of the received response message. The detection flag is preconfigured or determined by both parties through negotiation.

The sending module 102 is used for sending an IPsec SA detection message including a detection flag to the opposite end IPsec peer to enable it to return a response message; the receiving module 103 is used for receiving and parsing an IPsec SA response message returned by the opposite end IPsec peer and determining that IPsec SA of the opposite end peer is normal. The payload of the response message may be a same sequence number as that of the message sent, such that it is easy for the peer that sent the detection message to determine that the received IPsec SA message is a message responded by the opposite end peer. The payload also may be a sequence number generated randomly by the opposite end peer or may be any other content. As long as the received message is an IPsec SA message encrypted by the corresponding IPsec SA and may be decrypted normally by the local end after being received, it proves that IPsec SA of the opposite end peer is normal.

The counting module 104 is used for starting counting when the sending module 102 sends an IPsec SA detection message including a detection flag and if a response has not been received from the opposite end IPsec peer after the counting expires (i.e., the count reaches a predetermined threshold), the sending module 102 is informed to resend the detection message and counting for the resent message is initiated. If the number of detection message resending exceeds a predetermined number, IPsec SA of the opposite end peer is determined to be not existed and not normal.

The IPsec SA detection message is a data message encrypted by IPsec SA. In the IPsec/IKE networking environment, under normal conditions, IKE SA is used to maintain the control channel, e.g., to transmit notification message and so on, while IPsec SA is used to maintain the data channel, e.g., to encrypt and decrypt data messages and so on. In the present disclosure, IPsec SA messages are used for SA detection, that is, the data channel is used to perform the function of control messages, and thereby whether IPsec SA exists may be determined more accurately.

In an example, the payload content of the detection message is a sequence number generated randomly, which is encrypted and authenticated using IPsec SA and sent to the opposite end. The opposite end parses the message; and may select to encrypt the sequence number in the message and thereafter fill the encrypted sequence number back in the payload of the response message; and may also select to generate randomly a new sequence number, encrypt it and thereafter fill the encrypted sequence number back in the payload of the response message; and sends it to the active detecting party as a response message, such that the detecting party learns that the message is a response message to the detection message, whereby achieving the purpose of determining that IPsec SA of the opposite end peer is alive (i.e., normal).

Taking the real-time network conditions into account, if the detecting party has not received a response from the detected party for a period of time, it can resend the detection message. When the number of resending reaches an upper limit (e.g. 3 times), it determines that IPsec SA of the opposite end does not exist and the local IPsec SA can be removed.

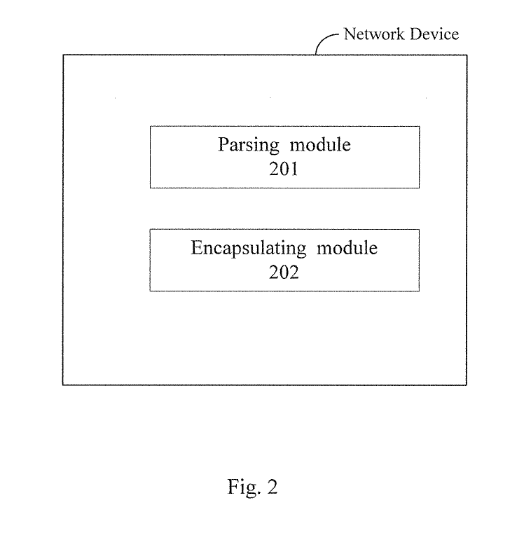

Referring to FIG. 2, from the perspective of response detection, a network device of the example may further be used to respond to an IPsec SA detection message including a detection flag sent by an opposite end peer. For example, the network device includes a parsing module 201 and an encapsulating module 202. The encapsulating module 202 may be the same as the encapsulating module 101 in FIG. 1, and FIG. 2 for example represents additional processing of the encapsulating module 101. The parsing module 201 is used for de-encapsulating a received IPsec SA message; and determining that the received message is a detection message if the message includes a detection flag; and determining that the received message is an IPsec SA data message if the message does not include a detection flag. The encapsulating module is used for re-encapsulating the parsed IPsec SA detection message into a response message to be sent to the detecting party. The payload content of the response message may be a sequence number encrypted and authenticated by IPsec SA corresponding to the detection message, and the sequence number may be consistent with that of the detection message and may also be a new sequence number generated randomly, of course. The payload content may be any content.

The modules shown in FIGS. 1 and 2 are shown in two network devices to represent the functions of an IPsec peer that sends a detection message (e.g., FIG. 1) and functions of the opposite end IPsec peer that receives and responds to the detection message (e.g., FIG. 2). However, all the modules of FIGS. 1 and 2 may be in each of the network devices so each of the network devices may send detection messages and respond to detection messages.

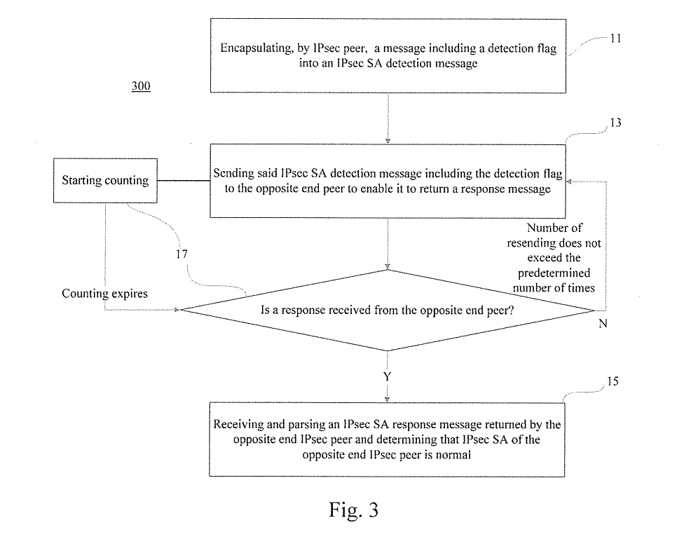

The present disclosure provides a method 300 for detecting whether IPsec SA of an opposite end peer is normal or not using an IPsec SA detection message including a detection flag, as shown in FIG. 3.

The method 300 includes, at block 11, encapsulating, by an IPsec peer, a message including a detection flag into an IPsec SA detection message, the payload content of the message being a sequence number encrypted and authenticated by IPsec SA. This block is performed by the encapsulating module 101.

The method 300 includes, at block 13, sending the IPsec SA detection message including the detection flag to the opposite end IPsec peer. This block is performed by the sending module 102.

The method 300 includes, at block 15, receiving and parsing an IPsec SA response message including the detection flag returned by the opposite end IPsec peer and determining that IPsec SA of the opposite end peer is normal. This block is performed by the receiving module 103.

The method 300 includes, at block 17, starting counting when sending the IPsec SA detection message including the detection flag; if a response has not been received from the opposite end IPsec peer after the counting expires, returning to block 13 to resend the detection message and initiating counting for the resending; if the number of resending exceeds a predetermined number of times, determining that IPsec SA of the opposite end IPsec peer does not exist. This block is performed by the counting module 104.

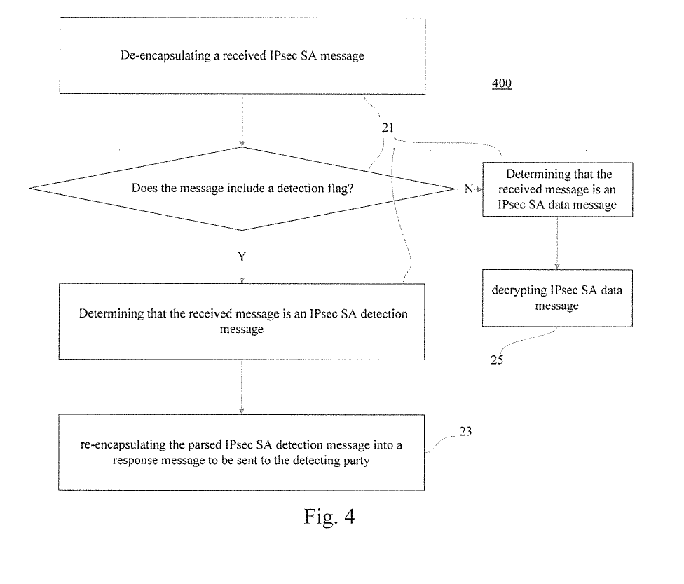

The method 300 to the process of sending a detection message. FIG. 4 shows a method 400 for responding to an IPsec SA detection message including a detection flag sent from an opposite end peer.

The method 400 includes, at block 21, de-encapsulating a received IPsec SA message; determining that the received message is a de-encapsulating a received IPsec SA message; determining if the message includes a detection flag; if the message includes a detection flag, determining the message is an IPsec SA detection message; and if the message does not include a detection flag, determining the message is an IPsec SA data message. This block is performed by the parsing module 201.

The method 400 includes, at block 23, re-encapsulating the parsed IPsec SA detection message into a response message to be sent to the detecting party, which for example is the IPsec peer that sends the IPsec SA detection message. This block is performed by the encapsulating module 202.

The method 400 includes, at block 25, decrypting the IPsec data message.

The payload content of the response message is a sequence number encrypted and authenticated by IPsec SA corresponding to the detection message. The sequence number may be consistent with that of the detection message, and may also be a new sequence number generated randomly. The payload content may be any content as well.

IPsec SA may include two operation modes. One is transport mode, in which only the transport layer data is used to calculate the AH or ESP header, and the AH or ESP header and the ESP encrypted user data are placed behind the original IP packet header. In general, the transport mode is applied to communication between two hosts, or communication between a host and a security gateway. The other is tunnel mode, in which the whole IP data packet of a user is used to calculate the AH or ESP header, and the AH or ESP header and the ESP encrypted user data are encapsulated in a new IP data packet. In general, the tunnel mode is applied to communication between two security gateways.

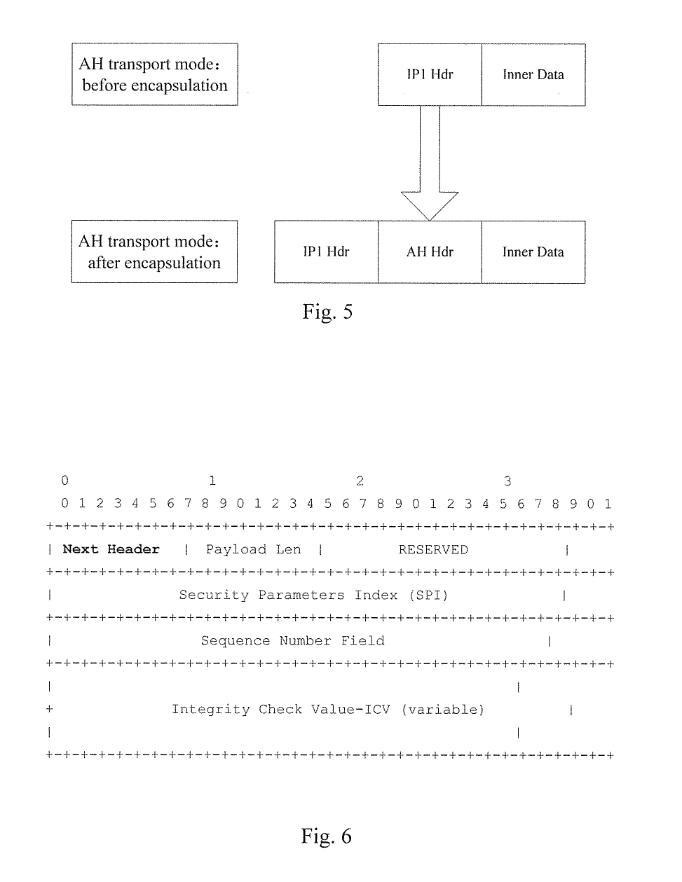

According to an example, through negotiation of both peers, it is determined that the detection flag for identifying a detection message is a special protocol number. FIG. 5 shows the format of a message before and after encapsulation for IPsec SA transport mode. As shown in FIG. 5, the format of a message before encapsulation is IP1 Hdr+Inner Data, wherein the protocol number for the Inner data for example is 255, which is a special number preconfigured or determined by both peers through negotiation, and does not conflict with already assigned protocol numbers. During implementation, the protocol number 255 may be replaced with any special protocol number, and the protocol number 255 is simply an example. As shown in FIG. 5 the encapsulation inserts the AH header for example between the IP1 header and the Inner Data. The format of the message is IP1 Hdr+AH header+Inner Data, wherein the protocol field of IP1 Hdr is 51, indicating that the next protocol type is AH. FIG. 5 shows that for encapsulation, the AH header is The source and destination addresses of the IP header are the addresses of the starting point and the ending point of the negotiated IPsec SA tunnel; the next header in AH is the special protocol number 255, indicating that the AH encapsulated data is IPsec SA detection data; and the content of the Inner Data is the sequence number. The IPsec peer encapsulates the message including the special protocol number in the AH encapsulation mode and thereafter sends it to the opposite end peer. FIG. 6 shows where the next header is located in the detection message format. The next header carries the special protocol number, e.g., 255, which is the detection flag.

After receiving this message, in the case that IPsec SA is operating normally, the opposite end IPsec peer, i.e., the detected party, executes the IPsec de-encapsulation process to obtain the original message IP1 Hdr+Inner Data, and thereafter obtain the protocol number of 255 corresponding to the IP upper layer data, indicating that this message includes IPsec SA detection data. The IPsec peer parses the data field to obtain the sequence number, and re-encapsulates into an IPsec SA response message, and sends the IPsec SA response message to the detecting party. The IPsec SA response message includes the sequence number and response Inner Data.

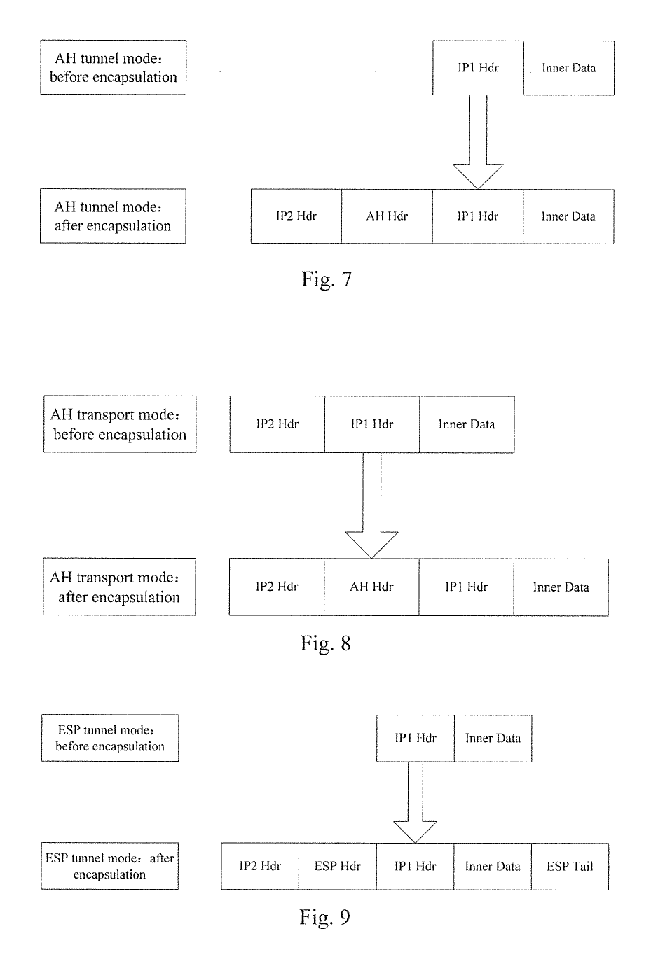

If the negotiated IPsec SA is in tunnel mode, the processing is similar to that in transport mode, and the format of a message before and after IPsec encapsulation are as shown in FIG. 7. After encapsulation the message format is: IP2 Hdr+AH header+IP1 Hdr header+Inner Data. The IP2 Hdr is the outer layer IP header, with its source and destination addresses being the addresses of the starting point and the ending point of the tunnel respectively, and IP1 Hdr is the inner layer IP header, with its source and destination addresses being in the range of flow messages protected by IPsec SA. The next protocol number of the inner layer IP1 Hdr is 255.

Under normal conditions, a message is sent over an interface of a peer. If the interface is configured with the IPsec policy (which includes an access control list (ACL)), and if the 5-tuple information of the message matches the configured ACL, IPsec encapsulation is performed. However, the message constructed in the present disclosure is a special IPsec SA detection message bypassing the above-mentioned ACL matching process, and is directly transmitted over the physical layer.

After receiving the message, the receiver searches SA according to the tuple to perform de-encapsulation. After the de-encapsulation is completed, when the protocol number is checked and determined to be 255, it is determined that the detection message sent from the opposite end does not match the IPsec policy of the interface, and the sequence number is filled back and is encapsulated into an IPsec SA response message, which is directly transmitted over the physical layer and is returned to the opposite end peer.

The present disclosure provides another example, in which, through negotiation of both peers, it is determined that the detection flag for identifying a detection message is reversely filled IP addresses. Taking the AH transport mode as an example, as shown in FIG. 8, the IP message before encapsulation is an IP in IP message, the source and destination addresses in IP2 Hdr are the addresses of the starting point and the ending point of the negotiated IPsec SA tunnel, and the source and destination addresses in IP1 Hdr are the reverse-filling of the source and destination addresses in IP2 Hdr. An example of reverse-filling is as follows: if the source address in IP2 Hdr is 1.1.1.1 and the destination address is 2.2.2.2, then the result of reverse-filling in IP1 Hdr is that the source address is 2.2.2.2 and the destination address is 1.1.1.1. FIG. 8 shows that the encapsulated message includes the AH header between the IP2 and the IP1 headers.

After receiving the message, the receiver enters a de-encapsulation process. After the receiver finds the SA, since it is a SA in transport mode, only the AH header is removed. Before removing the AH header, the receiver checks whether the type of the next payload in AH header is IP and whether the source and destination addresses are the reverse-filling of addresses of two gateways of the tunnel. The obtained two IP addresses behind the AH header are compared with the corresponding gateway addresses in IKE SA. If they are switched, it indicates that the addresses are reversely filled, then the IP2 Hdr is also removed and the inner layer message (IP1 Hdr+Inner Data) is recovered. Since the addresses have been reversely filled, the receiver determines that this message is a detection message and it can find according to IP1 Hdr that the route for response is pointing to the sender. Thus, the data (IP1 Hdr+Inner Data) is subjected to the process of encapsulating and forwarding again to be sent to the sender. In the encapsulated message, the two IP addresses are consistent, and the source and destination addresses are addresses of two gateways of the tunnel. After receiving the IP1 Hdr +AH Hdr+Inner Data, the sender performs the de-encapsulation process and finds that the two IP addresses are the same, and determines that the message is a response message from the opposite end, and updates the state of the detected SA as being available.

In the tunnel mode, taking ESP as an example, FIG. 9 shows the detection message format before and after encapsulation. The source and destination addresses in IP2 Hdr are the addresses of the starting point and the ending point of the negotiated IPsec SA tunnel, and the source and destination addresses in IP1 Hdr are the reverse-filling of the source and destination addresses in IP2 Hdr.

After receiving the message, the receiver enters a de-encapsulation process. After the receiver finds the SA, it removes the IP2 Hdr and the ESP Hdr to recover the original message (IP1 Hdr+Inner Data). Since the addresses have been reversely filled, the receiver determines at this moment that this message is a detection message and it can find according to IP1 Hdr that the route for response is pointing to the sender. Thus, the data (IP1 Hdr+Inner Data) is subjected to the process of encapsulating and forwarding again to be sent to the sender. The source addresses of IP1 Hdr and IP2 Hdr both are a gateway address of the detected party and the destination addresses both are a gateway address of the detecting party.

After receiving the IP2 Hdr+ESP Hdr+IP1 Hdr+Inner Data+ESP Tail, the sender performs a de-encapsulation process, finds that the source addresses of IP1 Hdr and HP2 Hdr both are a gateway address of the detected party and the destination addresses are a gateway address of the detecting party, it may determine that the message is a response message from the opposite end, and update the state of the detected SA as being available.

Through the designing of the present disclosure, whether IPsec SA of the opposite end peer is normal or not may be detected by sending a specially processed IPsec SA detection message. The technical solution makes small change to the message and performs well in terms of device compatibility.

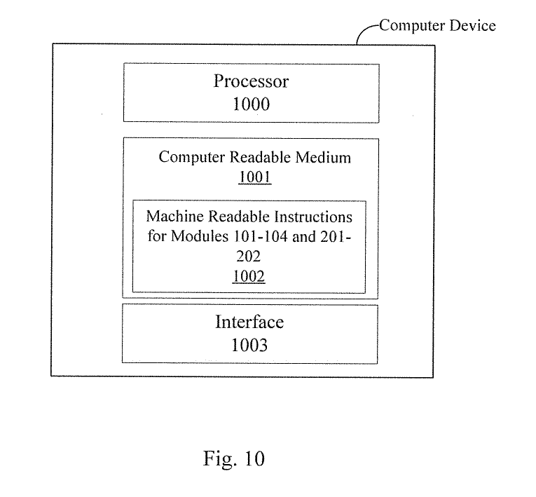

The above examples can be implemented by hardware, software or firmware or a combination thereof. For example the various methods, processes and functional modules described herein may be implemented by a processor (the term processor is to be interpreted broadly to include a CPU, processing unit, ASIC, logic unit, or programmable gate array etc.). The processes, methods and functional modules may all be performed by a single processor or split between several processers; reference in this disclosure or the claims to a ‘processor’ should thus be interpreted to mean ‘one or more processors’. The processes, methods and functional modules may be implemented as machine readable instructions stored on a non-transitory computer readable medium and executable by one or more processors, hardware logic circuitry of the one or more processors or a combination thereof. Further the processes, methods and functional modules may be implemented in the form of a software product. The computer software product is stored in a storage medium and includes a plurality of instructions for making a computer device (which can be a personal computer, a server or a network device such as a router, switch, access point etc.) implement the method recited in the examples of the present disclosure. FIG. 10 shows an example of a computer device (e.g., an IPsec peer) including a processor 1000, non-transitory computer readable medium 1001 and interface 1003. The non-transitory computer readable medium 1001 stores machine readable instructions 1002 for the modules 101-104 and 201-202 shown in FIGS. 1 and 2, which are executable by the processor 1000. The interface 1003 may be a network interface and may include ports if the computer device is a switch or router. The computer device may include other components that are not shown.

While the present disclosure describes various examples, these examples are to be understood as illustrative and do not limit the claim scope. Many variations, modifications, additions and improvements of the described examples are possible. All such variations, modifications, additions and improvements are within the scope of the present disclosure.

1. A network device, when acting as an Internet Protocol Security (IPsec) peer, for detecting whether IPsec Security Association (SA) of an opposite end IPsec peer is normal or not, wherein the network device comprises:
a processor;
an encapsulating module executed by the processor to encapsulate a message including a detection flag into an IPsec SA detection message;
a sending module to send the encapsulated message to the opposite end IPsec peer to enable it to return a response message; and
a receiving module to receive and parse an IPsec SA response message from the opposite end IPsec peer and determine that IPsec SA of the opposite end IPsec peer is normal.

2. The network device of claim 1, wherein the network device further comprises:
a counting module to start counting when the sending module sends an IPsec SA detection message including a detection flag; if a response has not been received from the opposite end IPsec peer after the counting expires, inform the sending module to resend the IPsec SA detection message, and initiate counting for resending; if a number of resending exceeds a predetermined number, determine that IPsec SA of the opposite end IPsec peer does not exist.

3. The network device of claim 1, wherein the detection flag is preconfigured or determined by the IPsec peer and the opposite end IPsec peer through negotiation; and payload content of the detection message is a sequence number encrypted and authenticated through the IPsec SA.

4. The network device of claim 1, wherein the opposite end IPsec peer is to:
receive the encapsulated message;
identify the detection flag from the received encapsulated message;
identify the message as a detection message from he identifying of the detection flag; and
return the IPsec SA response message, wherein the detection flag is a special protocol number or reversely filled source IP address and destination IP address.

5. The network device of claim 1, wherein the network device further comprises:
a parsing module to de-encapsulate an IPsec SA message received from the opposite end and determine that the received message is an IPsec SA detection message if the received message includes a detection flag and to re-encapsulate the parsed IPsec SA detection message into a response message to be sent to the opposite end; and to determine that the received message is an IPsec SA data message if the received message does not include a detection flag.

6. A method for detecting whether IPsec SA of an opposite end IPsec peer is normal or not, wherein the method comprises:
encapsulating, by an IPsec peer, a message including a detection flag into an IPsec SA detection message;
sending the IPsec SA detection message including the detection flag to the opposite end IPsec peer to enable it to return a response message;
receiving and parsing an IPsec SA response message returned by the opposite end IPsec peer and determining that IPsec SA of the opposite end IPsec peer is normal.

7. The method of claim 6, wherein the method further comprises:
starting counting when sending the IPsec SA detection message including the detection flag;
if a response message has not been received from the opposite end IPsec peer after the counting expires, resending the IPsec SA detection message and initiating counting for resending; and
if a number of resending exceeds a predetermined number of times, determining that IPsec SA of the opposite end IPsec peer does not exist.

8. The method of claim 7, wherein the detection flag is preconfigured or determined by the IPsec peer and the opposite end IPsec peer through negotiation to identify the message as a detection message; and the detection flag is a special protocol number or reversely filled source IP address and, destination IP address.

9. The method of claim. 6, wherein the method further comprises:
de-encapsulating a received IPsec SA message;
determining that the received message is an IPsec SA detection message if the message includes a detection flag and re-encapsulating the parsed IPsec SA detection message into a response message to be sent to the detecting party; and
determining that the received message is an IPsec SA data message if the message does not include a detection flag and decrypting the IPsec SA data message to process data in the IPsec SA data message.

10. The method of claim 9, wherein the payload content of the response message is a sequence number encrypted and authenticated through IPsec SA corresponding to the detection message.
